(19) United States
(12) Patent Application Publication
(10) Pub. No.: US 2002/0159481 A1
(43) Pub. Date: Oct. 31, 2002

(54) Telegraphic message transmitter and telegraphic message receiver

(76) Inventors: Sunao Takatori, Tokyo (JP); Hisanori Kiyomatsu, Tokyo (JP)

Correspondence Address: DARBY & DARBY P.C., POST OFFICE BOX 5257, NEW YORK, NY, 10150-5257, US

(21) Appl. No.: 10/089,123

(22) PCT Filed: Jul. 19, 2001
(86) PCT No.: PCT/JP01/06298

(30) Foreign Application Priority Data
Jul. 24, 2000 (JP) 2000-222680

(51) Int. Cl. H04J 3/24

(52) U.S. Cl. 370/474; 370/476

(57) ABSTRACT

Since the transmitting telegraphic message and the dummy telegraphic message are segmented into pieces respectively and are transmitted after they are mixed and the sequence is rearranged, it is difficult to seize the content of telegraphic message by wiretapping and the like.

The telegraphic message transmitter 10 segments the transmitting telegraphic message by the transmitting telegraphic message segmenting portion 11 and segments the dummy telegraphic message by the dummy telegraphic message segmenting portion 12 and rearranges the sequence of telegraphic messages by the telegraphic message sequence rearrangement portion 13. The control telegraphic message forming portion 14 forms the control telegraphic message comprising the control information to restore the rearranged telegraphic message into the original sequence. The data transmitting portion 15 converts the rearranged transmitting telegraphic messages into packets one by one and transmits them with consecutive packet numbers. The data transmitting portion 15 converts the control telegraphic messages into packets and transmits them separately from the telegraphic messages. The telegraphic message receiver 20 stores the received telegraphic messages in the received telegraphic message storing portion 22 by keeping them in correspondence with the packet consecutive numbers. The telegraphic message restoring portion 24 restores the original telegraphic message by restoring the sequence of the telegraphic messages into the original state based on the received control information and combining them.

### TECHNICAL FIELD

The present invention relates to a telegraphic message transmitter and a telegraphic message receiver, wherein a transmitting telegraphic message and a dummy telegraphic message are segmented into pieces and sent after the sequence thereof is rearranged so that the content of the telegraphic message is made difficult to be seized by wiretap and the like.

### BACKGROUND ART

With the spread of the Internet, the opportunity for transmitting information having high secrecy such as personal information and the like via an e-mail and the like is on the increase. When certain information is transmitted via Internet, its data is segmented into packets. A mark referred to as a header is attached to each of these packets and, in this header, the information such as a destination and a sequence by which the packets are assembled again and the like are stored. Because of the presence of this header, even if some lines are cut off, every packet can arrive at the destination by following some different routes and then the packets are reconstructed into its original state to reproduce the accurate information. According to this system, since many packets having different destinations can pass through on a single line, it can be concluded that its efficiency is extremely good and it is a good system for data communications.

The Internet is such that networks owned by areas or units of school or enterprise are mutually connected and, at connecting points thereof, computers referred to as routers are intervened. The router reads the header of the arriving packet and sends it back again to the destination and, with such process being repeated, the packet arrives at the final destination. In such a manner, the data (information) is transmitted in a relay fashion through the routers of the networks connected by the Internet and arrives at the destination and, therefore, such an information transmission system is referred to as “bucket relay system”.

Since the data passes through a large number of relay points by packet communication, there is a risk of the data being wiretapped on the way. Hence, in order to safely transmit and receive the data, various kinds of cryptogram systems are put into practice. A large amount of data processing is necessary for cryptographing a plain text into a cryptographed text which is hard to be decoded at the transmitter side and decoding the cryptographed text into a plain text at the receiver side, and therefore a program for cryptographing/decryptographing and the constitution of the transmitter-receiver become complicated so as to necessitate a processor having high throughput.

In Japanese Patent Laid-Open No.H9-18473, there is disclosed a data transmitter which conceals the user's data by a simple method to perform a data communication, by using a processor which is not provided with such high throughput that the whole of an user's data can be cryptographed for transmission. This data transmitter is constituted as follows. The user's data to be requested to be transmitted, is segmented into user's sub-data, and the user's sub-data segmented inside the packet to be transmitted are rearranged in a random order and, further, the packet data to be transmitted are intentionally rearranged in a random order. In addition, the data of the fixed length of communication control information (user's data sequential number, transmission confirmation information, retransmission information and the like) inside the packet data is cryptographed and transmitted. At the receiver side, the communication control information is decryptographed and the user's data is restored to the original state based on key information regarding the user's data sequential number contained there.

Further, in Japanese Patent Laid-Open No.2000-124891, there is disclosed a data transmitter, wherein the cryptographed data and the cryptogram form used for the cryptogram are not transmitted simultaneously, but transmitted individually and independently with a time difference therebetween so that the improvement of safety thereof can be expected.

### DISCLOSURE OF THE INVENTION

However, even in the data transmitter disclosed in the above-described Japanese Patent Laid-Open No.H9-18473, it is necessary to cryptograph/decryptograph the communication control information and a large amount of data processing is necessary to cryptograph/decryptograph the communication control information.

The present invention has been made in order to solve such problems and it is an object of the present invention to provide a telegraphic message transmitter and a telegraphic message receiver which make it difficult that a third party can seize the content of telegraphic message by simple data processing.

The telegraphic message transmitter of the present invention comprises a telegraphic message segmenting portion for segmenting a telegraphic message and a dummy telegraphic message into a plurality of telegraphic messages by a packet unit, a telegraphic message sequence rearrangement portion for rearranging the sequence of the telegraphic messages segmented by the telegraphic message segmenting portion and a data transmitting portion for transmitting the telegraphic message rearranged by the telegraphic message sequence rearrangement portion by packet communication system.

Further, the telegraphic message transmitter of the present invention comprises a telegraphic message segmenting portion for segmenting a transmitting telegraphic message and a dummy telegraphic message into a plurality of telegraphic messages by a packet unit, a telegraphic message sequence rearrangement portion for rearranging the sequence of the telegraphic messages segmented by the telegraphic message segmenting portion, a control telegraphic message forming portion for forming a control telegraphic message having control information to restore the telegraphic message rearranged by the telegraphic message sequence rearrangement portion into the original sequence and a data transmitting portion for transmitting by packet communication system the transmitting telegraphic message rearranged by the above described telegraphic message sequence rearrangement portion and the control telegraphic message formed by the above described control telegraphic message forming portion.

Further, the data transmitting portion separately transmits the transmitting telegraphic messages rearranged by the above described telegraphic message sequence rearrangement portion and the above described control telegraphic message so that the decryptographing of the telegraphic message by a third party can be made more difficult.

Further, the above described dummy telegraphic message has a content different from that of the above described transmitting telegraphic message, which is the content to prevent the seizure of the content of the transmitting telegraphic message and makes it more difficult to be seized the content of the transmitting telegraphic message.

Further, the telegraphic message receiver of the present invention comprises a data receiving portion for receiving the data by packet communication system, a received telegraphic message storing portion for storing the telegraphic message received by the data receiving portion and a telegraphic message restoring portion for eliminating the dummy message from the telegraphic message stored in the received telegraphic message storing portion to restore the telegraphic message by the rearrangement by a packet unit.

Further, the telegraphic message receiver of the present information comprises a data receiving portion for receiving the data by packet communication system, a received telegraphic message storing portion for storing the telegraphic message received by the data receiving portion, a control telegraphic message storing portion for storing the control telegraphic message received by the data receiving portion and a telegraphic message restoring portion for eliminating the dummy telegraphic message to restore the telegraphic message by the rearrangement by a packet unit based on the control telegraphic message stored in the above described control telegraphic message storing portion from the telegraphic message stored in the above described received telegraphic message storing portion.

The present specification contains the contents described in the specification and/or the drawings of Japanese Patent Application No. 2000-222680 which is a base of the priority of the present patent application.

### BRIEF DESCRIPTION OF THE DRAWINGS

FIG. 1 is a block diagram of a telegraphic message transmitter and a telegraphic message receiver according to the present invention;

FIG. 2 is a view showing the operation of a transmitting telegraphic message segmenting portion and a dummy telegraphic message segmenting portion;

FIG. 3 is a view showing the operation of a telegraphic message sequence rearrangement portion;

FIG. 4 is a view showing the examples of control information;

FIG. 5 is a view showing the operation of a data transmitting portion; and

FIG. 6 is a view showing the operation of a telegraphic message restoring portion.

### BEST MODE FOR CARRYING OUT THE INVENTION

Hereinafter, the preferred embodiments of the present invention will be described with reference to the accompanied drawings.

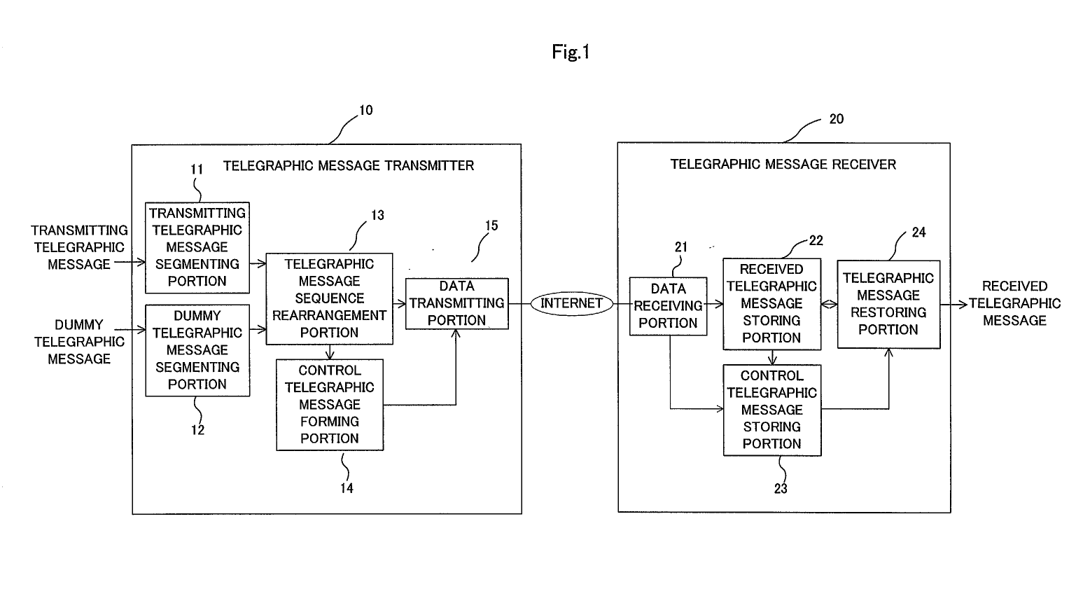

FIG. 1 is a block diagram of a telegraphic message transmitter and a telegraphic message receiver according to the present invention. The telegraphic message transmitter 10 comprises a transmitting telegraphic message segmenting portion 11 for segmenting a transmitting telegraphic message into a plurality of telegraphic messages, a dummy telegraphic message segmenting portion 12 for segmenting a dummy telegraphic message into a plurality of telegraphic messages, a telegraphic message sequence rearrangement portion 13 for rearranging the sequence of the segmented transmitting telegraphic messages and the segmented dummy telegraphic messages, a control telegraphic message forming portion 14 for forming a control telegraphic message having control information to restore the rearranged transmitting telegraphic messages into the original sequence and a data transmitting portion 15 for transmitting the rearranged segmented telegraphic messages and the control telegraphic message respectively by a packet communication system.

The telegraphic message receiver 20 comprises a data receiving portion 21, a received telegraphic message storing portion 22 for temporarily storing a received segmented telegraphic message, a control telegraphic message storing portion 23 for temporarily storing a received control telegraphic message and a telegraphic message restoring portion 24 for restoring the rearranged telegraphic messages into the original sequence based on the control information contained in the control telegraphic message.

The telegraphic message transmitter 10 and the telegraphic message receiver 20 are connected to each other via an open network such as Internet 30 and the like.

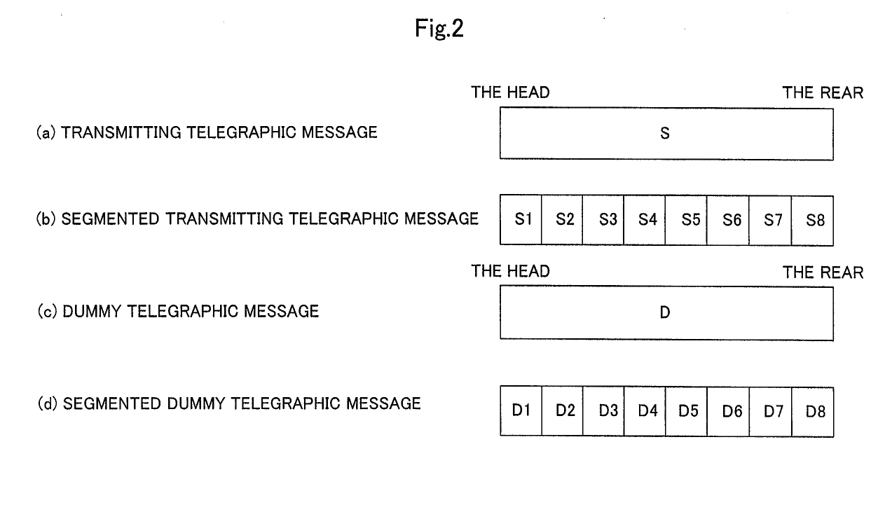

FIG. 2 is a view showing the operation of the transmitting telegraphic message segmenting portion and the dummy telegraphic message segmenting portion. Shown here is an example, wherein the transmitting telegraphic message and the dummy telegraphic message are segmented into eight telegraphic messages respectively. The transmitting telegraphic message segmenting portion 11 segments a transmitting telegraphic message S shown in FIG. 2a into eight telegraphic messages S1 to S8 as shown in FIG. 2b. The dummy telegraphic message segmenting portion 12 segments a dummy telegraphic message D shown in FIG. 2c into eight telegraphic messages D1 to D8 as shown in FIG. 2d. Note that the number of bytes to be segmented is random, and the number of bytes may differ in every segmented portion.

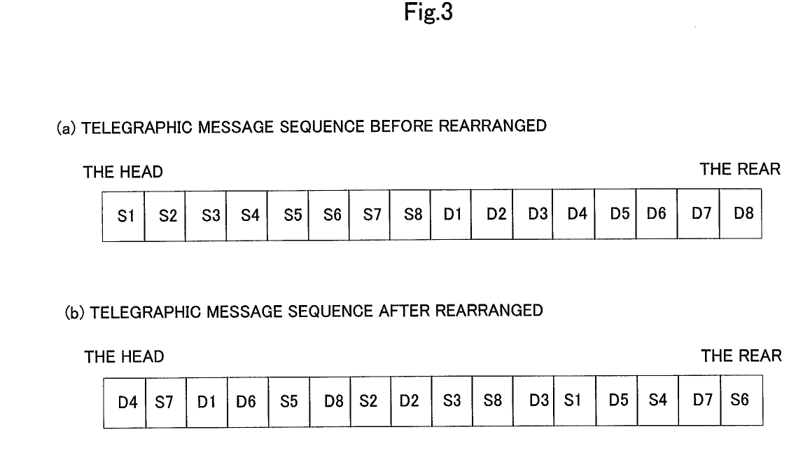

FIG. 3 is a view showing the operation of the telegraphic message sequence rearrangement portion. The telegraphic message sequence rearrangement portion 13, as shown in FIG. 3a, temporarily stores each of the segmented telegraphic messages S1 to S8, D1 to D8 in numeric order. The telegraphic message sequence rearrangement portion 13 recognizes the total number of the segmented telegraphic messages. Here, it recognizes the total number of the segmented telegraphic messages to be 16. The telegraphic message sequence rearrangement portion 13 generates random numbers sequentially within the total number of the segmented telegraphic messages, and performs the rearrangement of the sequence of telegraphic messages based on the generated random numbers. Note that the telegraphic message sequence rearrangement portion 13 is provided in advance with a plurality of rearrangement sequences, and may randomly extract one rearrangement sequence from them to perform the rearrangement of the sequence of telegraphic messages based on the extracted rearrangement sequence. Shown in FIG. 3b is an example of the rearrangement result of the sequence of telegraphic messages.

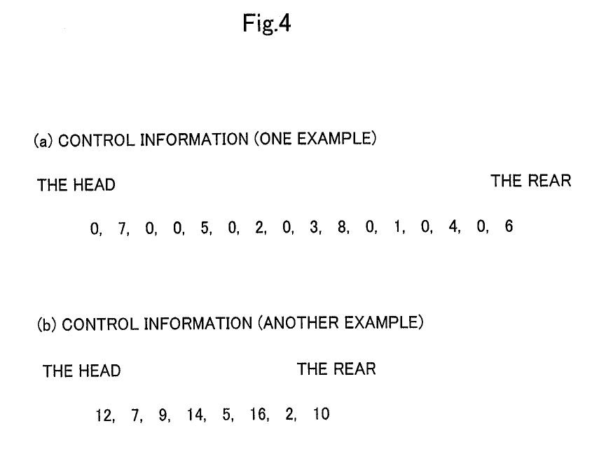

FIG. 4 is a view showing an example of the control information. The control telegraphic message forming portion 14 forms the control information for restoring the rearranged telegraphic messages into the original sequence based on the rearrangement result of the sequence of telegraphic messages. The control information shown in FIG. 4a illustrates the sequence of the rearranged telegraphic messages, and 0 indicates the dummy telegraphic message and 1 to 8 does the transmitting telegraphic message. Here, FIG. 4a shows that the first is the dummy telegraphic message, the second is the seventh of the segmented telegraphic messages, the third is the dummy telegraphic message, the fourth is the dummy telegraphic message, the fifth is the fifth of the segmented telegraphic messages . . . , and the last is the sixth of the transmitting telegraphic messages.

In another example of control information shown in FIG. 4b, the first (S1) of the segmented transmitting telegraphic messages is transmitted as the twelfth packet, the second (S2) of the segmented telegraphic messages is transmitted as the seventh packet, the third of the segmented telegraphic messages is transmitted as the ninthpacket . . . , and the eighth of the segmented telegraphic messages is transmitted as the tenth packet.

Note that, in FIG. 4, the control information comprising a character sequence punctuated by comma pauses is shown, but any symbols may be used as pause character, for example, a space character, a symbol character such as /, *, + and the like.

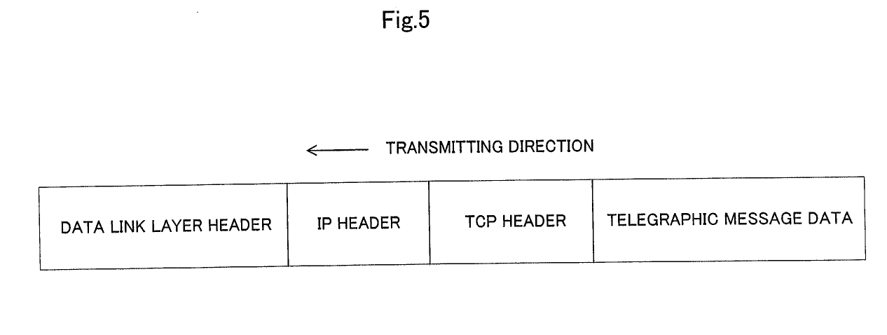

FIG. 5 is a view showing the operation of the data transmitting portion. The data transmitting portion 15 converts each of the rearranged telegraphic messages as shown in FIG. 3b into a packet corresponding to the protocol of Internet and transmits the formed packets sequentially. Specifically, a TCP header is attached in front of the segmented telegraphic message (telegraphic message data), and an IP header is further attached in front of the TCP header, and a header of a data link layer is further attached in front thereof, to perform the transmission. Here, the data transmitting portion 15 allocates 1 as the sequence number (consecutive number to show the order of the packet) inside the TCP header for the packet which transmits the first telegraphic message D4, 2 as the sequence number inside the TCP header for the packet which transmits the second telegraphic message S7 and attaches the sequence numbers 3, 4, 5, . . . respectively to each subsequent packet, to perform the transmission. Further, the data transmitting portion 15 attaches the IP address of the present telegraphic message transmitter 10 (computer of the telegraphic message transmitting side) to the originating IP address inside the IP header and the IP address of the destination (computer at the telegraphic message receiving side having the telegraphic message receiver 20) to the destination (destination of the transmission) IP address inside the IP header.

The data transmitting portion 15 completes the communication after all the segmented telegraphic messages are made into packets and transmitted. After that, it generates a request for restart of the communication with the telegraphic message receiver 20 and converts the control telegraphic messages formed in the control telegraphic message forming portion 14 into packets and transmits them. Note that, immediately after all the segmented telegraphic messages are converted into packets and transmitted, the data transmitting portion 15 may convert the control telegraphic messages into packets and transmit them without completing the communication.

Note that, between the data transmitting portion 15 and the data receiving portion 21, confirmation processing of the arrival of packet, retransmission processing when a normal arrival of the packet could not be performed and the like are performed. Note that these processing and the like are regulated by the TCP protocol and the IP protocol.

When the received packet is a telegraphic message packet, the data receiving portion 21 at the telegraphic message receiver 20 side supplies the telegraphic message in the telegraphic message packet to the received telegraphic message storing portion 22 and, when the received packet is a control packet, supplies the control information (control telegraphic message) in the control packet to the control telegraphic message storing portion 23.

Note that the data receiving portion 21 determines whether the data is the telegraphic message or the control messages based on the data of the received packet. Specifically, when the received data is the data punctuated by pause characters and the like, it is determined to be the control information and otherwise it is determined to be the telegraphic message. Note that, if the data is constituted by a plurality of packets, it may be determined to be the telegraphic message and, if it is a single packet, it may be determined to be the control information. Further, at the data transmitting portion 15 side, the information for distinguishing the telegraphic message from the control information may be inserted inside the TCP header and transmitted, and the data receiving portion 21 may distinguish the telegraphic message from the control information based on the information inserted inside the TCP header. Further, when the control packet is transmitted from the data transmitting portion 15, the information showing that the packet is the control information may be inserted in the data portion, and the data receiving portion 21 may determine whether the packet is the telegraphic message or the control information based on whether the information showing that the packet is the control information is inserted inside the data portion or not.

The received telegraphic message data is temporarily stored in the received telegraphic message storing portion 22 by being kept in correspondence with the sequence number of the packet (consecutive number showing the order of the packet). Further, the received control information is temporarily stored in the control telegraphic message storing portion 23.

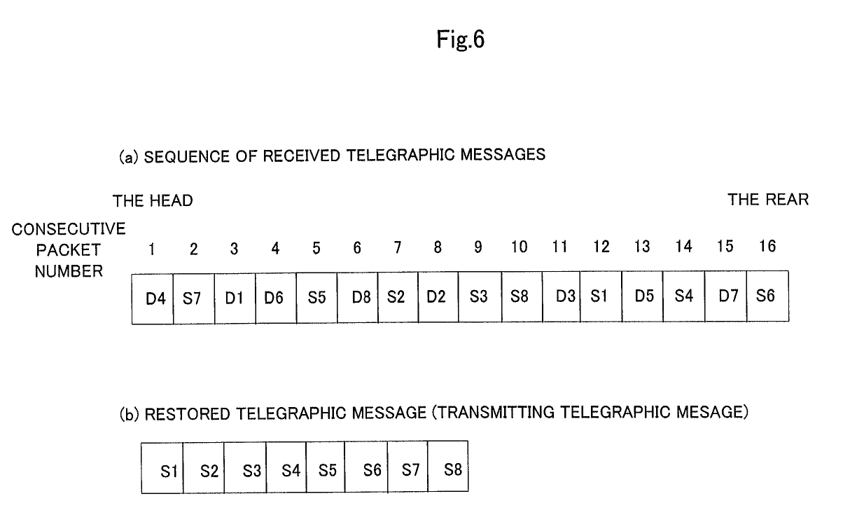

FIG. 6 is a view showing the operation of the telegraphic message restoring portion. The telegraphic message restoring portion 24 extracts the telegraphic message stored in the received telegraphic message storing portion 22 based on the control information stored in the control telegraphic message storing portion 23 to restore the received telegraphic message. Specifically, the first of the segmented telegraphic messages is taken out from the telegraphic messages stored in the received telegraphic message storing portion 22 shown in FIG. 6a based on the control information and then the second, the third of the segmented telegraphic messages, . . . are taken out sequentially and the telegraphic messages are combined to one another in order as taken out so that, as shown in FIG. 6b, the original telegraphic message (transmitting telegraphic message) before the segmentation is restored.

Since the telegraphic message transmitter according to the present invention segments the telegraphic message into pieces and rearranges the sequence, the data to be transmitted on Internet 30 is of a plain text, though it is in fragments. However, since the meaningful transmitting telegraphic message and the dummy telegraphic message are in a state of mixed fragments, even if the data to be transmitted on Internet 30 is wiretapped, it is difficult to seize the content of the transmitting telegraphic message. Furthermore, by elaborating the content of the dummy telegraphic message, the seizure of the content of the telegraphic message can be made more difficult. For example, in the case that the original content of the transmitting telegraphic message is “vote for the plan A”, the content of the dummy telegraphic message may be made as “vote for the plan B” or “oppose to the plan A” so that the seizure of the content by a third party can be made more difficult. Note that the dummy telegraphic message may be prepared by the transmitter himself or may be automatically formed by using the computer.

FIG. 1 shows a constitution, wherein the telegraphic messages segmented at the telegraphic message transmitter 10 side are randomly rearranged and the control information regarding the rearrangement sequence is transmitted as the control telegraphic message (control packet). However, when the rearrangement sequence is set in advance by the transmitter side and the receiver side, the transmission and reception of the control telegraphic message (control packet) is unnecessary. In this case, it is not necessary to provide the control telegraphic message forming portion 14 and the control telegraphic message storing portion 23. In the present invention, unless the control packet is opened, the sequence to restore the segmented telegraphic messages cannot be determined. Accordingly, if a routing history of the control packet and a confirmation whether it is opened or not are checked, an accurate seizure of the content of the telegraphic message by a third party can be prevented. Thus, when the control packet passes through each router, if the information (for example, the URL of router) which specifies that router is additionally recorded in the control packet, a router log can be obtained as to through which routers the control packet has reached the receiving side. Further, if the information to the effect that the control packet is opened is recorded in the control packet when it happened and the information to the effect that the control packet is reproduced is recorded in the control packet when it happened, it is possible to specify whether any illegal accesses are made or not at the time when the control packet is received. When the packet having a record to the effect that it is opened on the way is received, the telegraphic message receiver 20 informs the telegraphic message transmitter 10 of that effect and discards the received telegraphic message to eliminate the risk of reproducing an abnormal telegraphic message. As described above, since according to the present invention the transmitting telegraphic message and the dummy telegraphic message are segmented into pieces at the transmitting side and their sequences are rearranged before transmission, they are in fragments and contain the dummy telegraphic messages and therefore it is impossible to accurately seize the content of the telegraphic message even if it is wiretapped. Since the present invention does not employ at all any cryptographing processing/decryptographing processing such as a common key system, an open key system and the like, it is possible to make the constitutions of the transmitting side and the receiving side simple as well as the data processing.

It is to be noted that all the publications, patents and patent applications that were referred to in the present specification should be incorporated in the present specification as they are.

### INDUSTRIAL APPLICABILITY

The present invention is advantageous in enhancing secrecy of transmission and reception of the telegraphic message.

1. A telegraphic message transmitter comprising;
a telegraphic message segmenting portion for segmenting a transmitting telegraphic message and a dummy telegraphic message into a plurality of telegraphic messages by a packet unit;
a telegraphic message sequence rearrangement portion for rearranging the sequence of the telegraphic messages segmented by the telegraphic message segmenting portion; and
a data transmitting portion for transmitting by a packet communication system the transmitting telegraphic messages rearranged by the telegraphic message sequence rearrangement portion.

2. A telegraphic message transmitter comprising:
a telegraphic message segmenting portion for segmenting a transmitting telegraphic message and a dummy telegraphic message into a plurality of telegraphic messages by a packet unit;
a telegraphic message sequence rearrangement portion for rearranging the sequence of the telegraphic messages segmented by the telegraphic message segmenting portion;
a control telegraphic message forming portion for forming a control telegraphic message having control information to restore the transmitting telegraphic messages rearranged by the telegraphic message sequence rearrangement portion into the original sequence; and
a data transmitting portion for transmitting by a packet communication system the transmitting telegraphic messages rearranged by said telegraphic message sequence rearrangement portion and the control telegraphic message formed by said control telegraphic message forming portion.

3. The telegraphic message transmitter according to claim 2, wherein
said data transmitting portion separately transmits the transmitting telegraphic messages rearranged by said telegraphic message sequence rearrangement portion and said control telegraphic message.

4. The telegraphic message transmitter according to claim 1 or 2, wherein
said dummy telegraphic message has a content different from the content of said transmitting telegraphic message, which is the content to prevent the seizure of the content of the transmitting telegraphic message.

5. A telegraphic message receiver comprising;
a data receiving portion for receiving the data by packet communication system;
a received telegraphic message storing portion for storing the telegraphic message received at the data receiving portion; and
a telegraphic message restoring portion for eliminating the dummy telegraphic message from the telegraphic messages stored in the received telegraphic storing portion and restoring the telegraphic messages by rearrangement by a packet unit.

6. A telegraphic message receiver comprising;
a data receiving portion for receiving a data by a packet communication system;
a received telegraphic message storing portion for storing the received telegraphic message received at the data receiving portion;
a control telegraphic message storing portion for storing the control telegraphic message received at the data receiving portion; and
a telegraphic message restoring portion for eliminating the dummy telegraphic message from the telegraphic messages stored in said received telegraphic message storing portion based on the control telegraphic message stored in said control telegraphic message storing portion and restoring the telegraphic messages by rearrangement by a packet unit.
